(19) United States
(12) Patent Application Publication
(10) Pub. No.: US 2011/0016174 A1
(43) Pub. Date: Jan. 20, 2011

(54) Weighing System

(75) Inventors: Steffen Michael Rohm, Sigmaringen (DE); Maik Juergen Frank Weiss, Neuhausen ob Eck (DE); Gunther Off, Balingen (DE); Dagmar Haller, Balingen (DE); Gerhard Ludwig, Albstadt (DE); Robert Winkler, Bisingen (DE); Ralf Grespan, Balingen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bizerba GmbH & Co. KG, Balingen (DE)

(21) Appl. No.: 12/867,422

(22) PCT Filed: Feb. 16, 2009
(86) PCT No.: PCT/EP2009/001069

§ 371 Date: Oct. 5, 2010

(30) Foreign Application Priority Data
Feb. 14, 2008 (DE) 10 2008 009 116.2

(51) Int. Cl. G06F 15/16

(52) U.S. Cl. 709/203

(57) ABSTRACT

The invention relates to a weighing system with a Client-Server architecture, wherein the server is designed to provide services to a client on request a Client-Server communication provider being provided, wherein the services are registered and which is designed to deliver a service requested by the client. Delivery of the service is provided directly between the client and a dedicated server.

The present invention relates to a weighing system having a client-server architecture, wherein the servers are configured to provide services to a client on request.

A client-service architecture is generally known. A server is a software module which offers a service. Another software module, the client, a user interface, for example, can request this service. Clients and servers can run on different devices or on the same device.

So that a client can access a service, the connection data of the corresponding service, for example its address, must be known to the client. If a new service is added to an existing client-service architecture, each client must be advised of the connection data of the new service. This is laborious, however.

It is the object of the present invention to provide a weighing system of the initially named kind, for example, a set of store scales or a combination unit comprising a set of store scales and further devices such as display terminals, cash register systems, printer systems and/or hardware servers, which avoids the disadvantage explained above.

This object is satisfied by a weighing system having the features of claim 1 and in particular in that a client-server communications broker is provided in which the services are registered and which is configured to broker a service requested by the client, wherein the provision of the requested service takes place directly between the client and a server determined for this purpose.

All the services present are registered at the client-server communications broker. A client which wants to access the services therefore does not have to know the connection data of the services. The client rather only needs to send a request for a respective service to the client-server communications broker which is aware of the connection data of the services and which then brokers the respective requested service. If a new service is subsequently added, for example by installation of a new software module, this only has to be registered with the client-server communications broker. It is not necessary to communicate the connection data of the new service to the clients.

The software implemented on the weighing system is therefore not influenced by service changes which can above all frequently occur in distributed systems. Additional software modules or additional hardware having new functions, for example a user recognition, can in particular be added over the course of time. A better maintenance capability and a simpler expandability of a weighing system can be achieved overall.

It is generally possible that the client sends a request to the client-server communications broker which determines the server offering the requested service and forwards the request to the determined server which provides the requested service to the client-server communications broker which then forwards the service to the requesting client. In accordance with the invention, the provision of the requested service takes place directly between the client and a server determined for this purpose. The effort on the part of the client-server communications broker can hereby be reduced since the latter is only used at the start and is otherwise not involved in the communication between the client and the server.

The client-server communications broker preferably includes a system of rules or a default for the starting and/or terminating of services and/or for the selection of the determined server. The system of rules is preferably a script which is stored in replaceable form in a file. Which services are started as a base configuration on a system start of the weighing system can, for example, be laid down in the system of rules. Furthermore, it can also be laid down in the system of rules whether a specific service may be started at all. It can, for example, be laid down that a service may only be started when sufficient hardware resources are present for this purpose, when it is permitted from a technical calibration aspect and/or when a license had been acquired for the respective service.

The requested service is preferably offered by a plurality of servers and the client-server communications broker is configured to determine the server from the plurality of servers which provides the requested service by an automatic selection with reference to the system of rules and to communicate the determined server to the client. A client can, for example, request a service “print”, wherein e.g. the following three different print services are available: a calibrated print service, a local print service and a remote print service. The client-server communications broker then decides which of the three print services is selected for the provision of the “print” service. The client therefore does not request a specific service (e.g. the local print service), but rather generally a function of a service (printing). The rule-based reading out can, for example, comprise selecting that print service which has already started from a local print service and a remote print service. This has the advantage of being particular resource-saving so that as little computing capacity or memory space as possible is required. This in particular makes it possible to work with weighing systems having relatively tight hardware resources.

In accordance with an embodiment of the invention, the provision of the requested service takes place in accordance with the publisher-subscriber model. In this case the client (=subscriber) subscribes to the data corresponding to the requested service with the server and said data are then automatically communicated, in particular at regular intervals or as soon as new or updated data are available at the server. The client then does not have to constantly query the server whether new or updated data are present.

To start the services, a service manager can be provided which is connected to the client-server communications broker and which has an autostart list with services to be started on the system start of the weighing system. The service manager can, however, also be integrated in the client-server communications broker. The service manager can furthermore have a further list in which services to be re registered which are only or are also only started at the request of the client-server communications broker. All the available data therefore do not have to be started directly on the system start.

The service manager can also allow a dynamic starting of services on request. Services not started at the system start can therefore also be added to the client-server architecture in a simple manner later. Services can generally be provided whose start takes place dependent on requirements. The start can take place automatically and in particular via the service manager.

The service manager is preferably configured to communicate the connection data of the client-server communications broker, which are in particular made separate, to every started service so that the started services can in each case register with the client-server communications broker which then allocates its connection data to the started services.

Services which are not needed or are no longer needed can in particular also be terminated by means of the service manager. The termination of the services not needed provides advantages in the configuration of the hardware. The hardware resources can then be configured with lower performance, that is can in particular be dimensioned more cost-favorably since all services do not always have to be active at a specific time. The client-server communications broker can generally be configured to terminate a service no longer needed.

A registration of a service to be added in particular takes place in the service manager on the installation of the service to be added.

In accordance with another embodiment of the invention, servers subject to mandatory calibration and servers not subject to mandatory calibration can be coupled to one another via feedback-free software interfaces to protect the services to be provided by the servers subject to mandatory calibration, for example weight display or price calculation. The feedback-free software interfaces are components of the servers subject to mandatory calibration and are, for example, made in each case as a filter which carries out a data control in that e.g. the plausibility, the origin or the checksum of the data are evaluated. A secure client-server architecture can thus be provided in which falsified data or manipulated data have no negative effect on the function of the client-server architecture. In this manner, in particular the most varied certification requirements can be satisfied which are made on the security of a set of scales.

The data corresponding to a service provided by a server subject to mandatory calibration are preferably provided with a code or an ID, for example with a hash-code. It can thereby be achieved that data subject to mandatory calibration are only exchanged between servers authorized by a responsible position. Data which are transmitted from an unauthorized server to an authorized server are not accepted there. Data which are sent from an authorized server to an unauthorized server lose their status as data subject to mandatory calibration. In particular only such data are accepted by the servers whose ID is stored in a memory and is thus known to the receiving server.

It is preferably known to the client-server communications broker whether a respective client and/or service is/are a calibrated or non-calibrated client and/or service. This in particular makes it possible that the brokering of a calibrated service requested by a non-calibrated client takes possible via a feedback-free software interface.

In accordance with a further embodiment of the invention, the weighing system is made as a distributed weighing system and/or as a combined weighing system. In this case, a plurality of devices or all the devices of the distributed weighing system can each have a client-server communications broker and the client-server communications brokers can communicate with one another. Such a weighing system can, for example, include a set of complex scales, a set of simple scales, display terminals, cash register systems, printer systems and/or hardware servers with a high computation power. The individual services can be distributed among the devices in such a weighing system. Computation-intensive servers can in particular run on a central hardware server so that the terminals require less hardware. A client of a terminal, for example a user interface, can nevertheless access all services and e.g. request an optical image evaluation for a user recognition. Such a weighing system also makes possible a continuous serving of a customer in a store or supermarket.

A weighing system includes at least one set of scales having a weighing cell for the detection of the weight of a product to be weighed. The a set of scales can in this respect have a housing with an integrated weighing cell and a load plate connected to the weighing cell. An input apparatus such as a keyboard or a touch screen and an output apparatus such as a printer or a monitor are preferably connected to the a set of scales.

A set of scales or a plurality of sets of scales arranged spatially distributed can be integrated into a such a weighing system and in turn have input or output apparatus and/or access input apparatus or output apparatus arranged distributed in the weighing system. In addition, the weighing system can have on or more servers which are arranged locally and/or are spatially far away and e.g. run as remote servers. In addition, the weighing system can include further components such as a cash register and/or an audio output for the output of audio files and/or a voice output for voice guidance of users and/or customers. Equally, the weighing system can include a communications apparatus, preferably a modem, to communicate with other data networks.

The present invention furthermore relates to a method for the operation of a weighing system having a client-server architecture, wherein the servers provide services offered to a client on request, wherein the services offered are registered with a client-server communications broker which brokers a service requested by the client, wherein the requested service is provided directly between the client and a server determined for this purpose.

Further preferred embodiments of the invention are described in the dependent claims.

The invention will be described in the following by way of example with reference to the drawing. There are shown, schematically in each case:

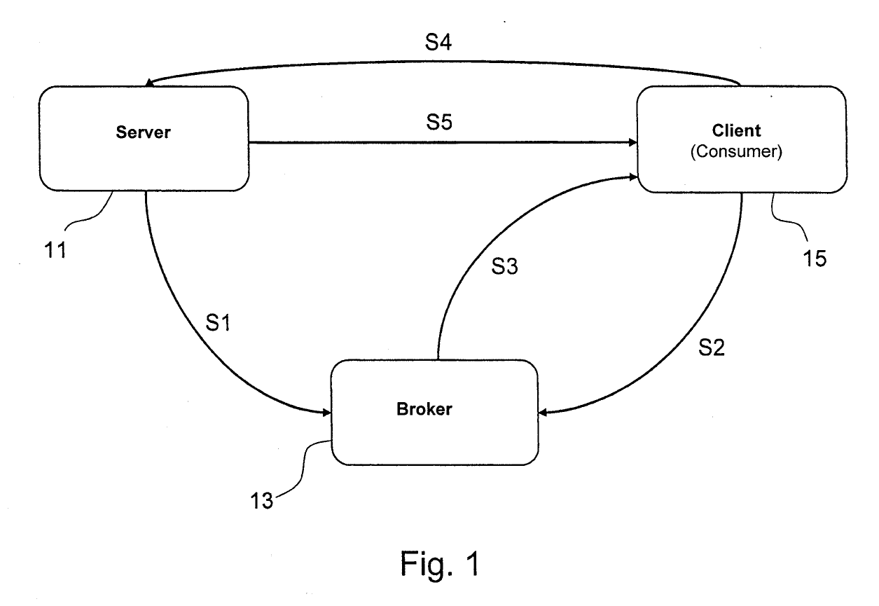

FIG. 1 the brokering of a service of a server to a client through a client-server communications broker;

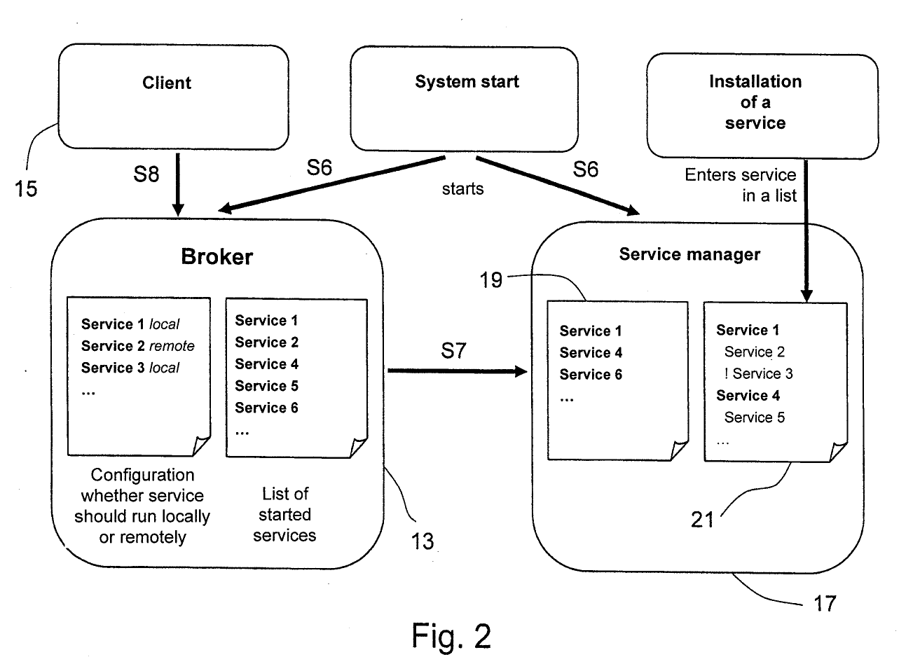

FIG. 2 a client-server communications broker and a service manager of a weighing system in accordance with the invention;

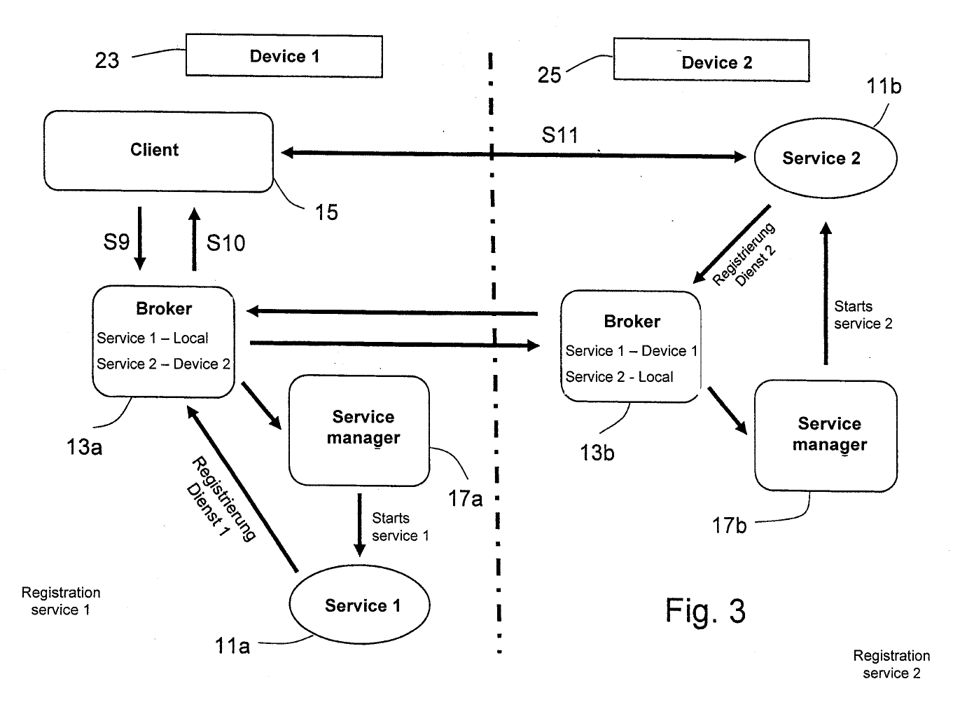

FIG. 3 the interaction of the client-server communications brokers of two devices of a combined unit;

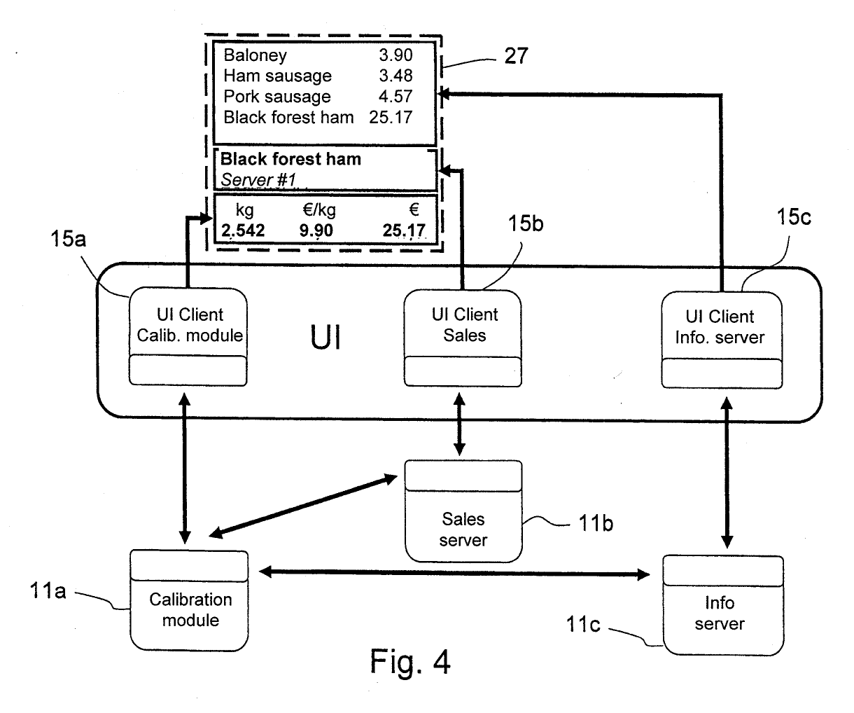

FIG. 4 a display of a weighing system in accordance with the invention; and

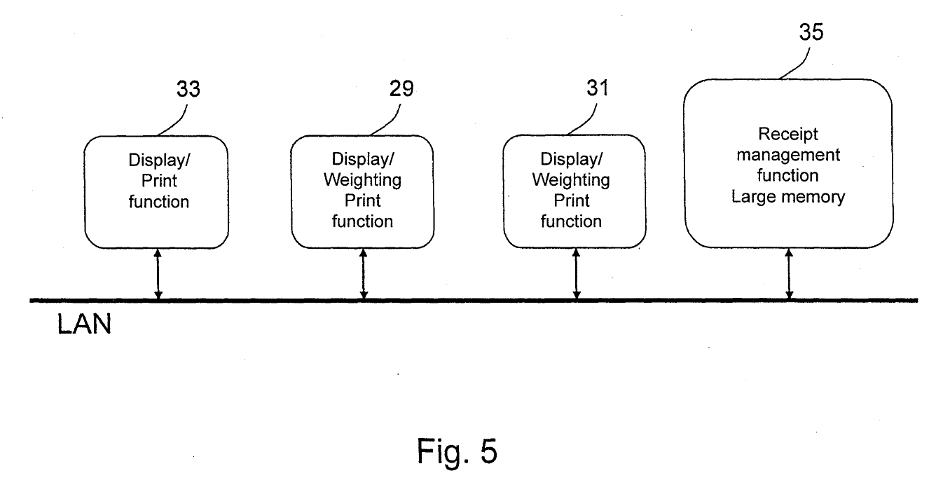

FIG. 5 a distributed weighing system in accordance with the invention.

In FIG. 1, a client-server architecture of a weighing system is shown having a server 11, a client 15 and a client-server communications broker 13 which will be called a broker in the following. On the system start of the weighing system, which will be explained in more detail in FIG. 2, the server 11 registers with the service offered by it at the broker 13 (step S1). The client 15, which would like to access the offered service, contacts the broker 13 for this purpose to request the offered service (step S2). The client 15 thereupon receives the connection data (address) of the server 11 offering the service from the broker 13 (step S3). The client 15 can then enter into contact directly with the server 11 offering the service (step S4) so that the provision of the service can then take place directly from the server 11 to the client 15 (step S5).

In accordance with FIG. 2, the broker 13 and a service manager 17 are started on the system start of the weighing system (step S6). The service manager 17 includes an autostart list 19 in which those services are registered which should be started on the system start. The service manager 17 furthermore includes a further list 21 into which those services are also registered, in addition to the services already starting on the system start, which should only be started on a specific demand of the broker 13 (step S7), wherein a demand of the broker 13 is triggered by a request of a client 15 (step S8). There can be dependencies between the services. It can, for example, be necessary on the start of a service additionally to start another service or it can occur that specific services may not be started simultaneously. If a new service is installed on the weighing system, the new service is registered at least in the further list 21. The service manager 17 communicates the services started by it of the connection data of the broker 13 so that the started services can be registered at the broker 13. The broker 13 then allocates their connection data to the started services.

FIG. 3 shows a distributed weighing system with two units 23 and 25. A server 11a (service 1). a broker 13a, a client 15 and a service manager 17a are installed on the device 23. A server 11b (service 2), a broker 13b and a service manager 17b are installed on the device 25. The services 1 and 2 are registered with the two brokers 13a and 13b. For broker 13b, service 1 is a local service and service 2 is a remote service on device 2. For broker 13a, service 1 is a remote service on device 1 and service 2 is a local service. The connection data of services 1 and 2 are exchanged between the brokers 13a and 13b. If the client 15 requests service 2 from the broker 13a (step S9), it receives the connection data on service 2 on device 25 from the broker 13a (step S10) and can then enter directly into communication with it (step S11).

In FIG. 4, a display device of a weighing system is shown in the form of a display 27 which is divided into three fields, with each field being controlled by a separate client 15a, 15b, 15c made in each case as a user interface. The upper part of the display 27 is controlled by the client 15c which makes use of the service of an information server 11c to display information on different articles and base prices for these articles.

The middle part of the display 27 is controlled by a client 15b which makes use of the service of a served sale server 11b to display data on a served sale, wherein the data shown in the middle display are communicated in accordance with the publisher-subscriber model from the server 11b to the client 15b. In a base state of the server 11b, the display on the middle part of the display 27 is blank, for example. As soon as the server 11b changes into a state “article call”, data corresponding to the called up article are communicated to the client 15b and the middle part of the display 27 shows the called up article. If the called up article is then registered by pressing a register button, the server 11b automatically communicates corresponding data to the client 15b, whereby the name of the operator of the weighing system is displaced in the middle part of the display 27, for example.

The lower part of the display 27 is controlled by a client 15a which makes use of the service of a server 11a subject to mandatory calibration to display a weight, a base price and a calculated price for the called up article.

The servers 11a, 11b, 11c are in this respect in communications connection with one another. The server 11a subject to mandatory calibration can, for example, communicate base prices to the information server 11c. In addition, the served sale server 11b can communicate the called-up article to the server 11a subject to mandatory calibration.

FIG. 5 shows a weighing combination comprising a set of scales 29, a further set of scales 31, a cash register 33 and a hardware server 35. The two sets of scales each have the functions of displaying, weighing and printing. The cash register 33 has the functions of displaying and printing. The hardware server 35 has a large memory and a receipt management function. The data transfer between the individual devices 29, 31, 33, 35 can take place by any desired communications medium, e.g. an open bus system or the internet or a field bus. A continuous serving of a customer can be implemented using the weighing combination presented. The customer receipt can therefore be accessed from any terminal, i.e. the purchasing of a customer can be started, continued and/or completed at any terminal.

### REFERENCE NUMERAL LIST

11 server
13 broker
15 client
17 service manager
19 autostart list
21 further list
23 device
25 device
27 display
29 set of scales
31 set of scales
33 cash register
35 hardware server
S1-S11 method steps

1-15. (canceled)

16. A weighing system having a client-server architecture, wherein the servers (11) are configured to provide a client (15) with services on request; wherein a client-server communications broker (13) is provided in which the services are registered and which is configured to broker a service requested by the client, wherein the provision of the requested service takes place directly between the client (15) and a server (11) determined for this purpose.

17. A weighing system in accordance with claim 16 characterized in that the client-server communications broker (13) includes a system of rules for the starting and/or terminating of services and/or for the selection of the determined server (11).

18. A weighing system in accordance with claim 17 characterized in that the requested service is offered by a plurality of servers (11) and the client-server communications broker (13) is configured to determine the server (11) providing the requested service from the plurality of servers (11) by automatic selection with reference to the system of rules and to communicate the determined server (11) to the client (15).

19. A weighing system in accordance with claim 16, characterized in that the provision of the requested service takes place in accordance with a publisher-subscriber model.

20. A weighing system in accordance with claim 16, characterized in that a service manager (17) is provided for the starting of the services which has an autostart list (19) with services to be started on the system start of the weighing system, with a registration of the service to be added into the service manager (17) preferably taking place on the installation of a service to be added.

21. A weighing system in accordance with claim 16, characterized in that services are provided whose start takes place in dependence on requirements.

22. A weighing system in accordance with claim 16, characterized in that the client-server communications broker (13) is configured to terminate a service no longer required.

23. A weighing system in accordance with claim 16, characterized in that servers subject to mandatory calibration and servers not subject to mandatory calibration are coupled to one another via feedback-free software interfaces.

24. A weighing system in accordance with claim 23, characterized in that the data corresponding to a service provided by a server subject to mandatory calibration are provided with a code or an ID.

25. A weighing system in accordance with claim 16, characterized in that it is known to the client-server communications broker (13) whether a respective client and/or service is/are a calibrated or non-calibrated client and/or service.

26. A weighing system in accordance with claim 25, characterized in that the brokering of a service subject to mandatory calibration requested by a client not subject to mandatory calibration takes place via a feedback-free interface.

27. A weighing system in accordance with claim 16, characterized in that the weighing system is made as a distributed weighing system.

28. A weighing system in accordance with claim 27, characterized in that a plurality of devices (23, 25) of the distributed weighing system each have a client-server communications broker (13) and the client-server communication brokers (13) are in communications connection with one another.

29. A weighing system in accordance with claim 16, characterized in that the client-server communications broker (13) and/or the service manager (17) has/have a processor and a memory connected to the processor and is/are connected to the client-server architecture via an interface.

30. A method for the operation of a weighing system having a client-server architecture, wherein the servers (11) provide a client (15) with services on request, wherein the services are registered with a client-server communications broker (13) which brokers a service requested by the client (15), wherein the requested service is provided directly between the client (15) and a server (11) determined for this purpose.
